(19) United States
(12) Patent Application Publication
(10) Pub. No.: US 2016/0004139 A1
(43) Pub. Date: Jan. 7, 2016

(54) TUNABLE NONLINEAR BEAM SHAPING BY A NON-COLLINEAR INTERACTION

(71) Applicant: RAMOT AT TEL-AVIV UNIVERSITY LTD., Tel Aviv (IL)

(72) Inventors: Ady ARIE, Herzeliya (IL); Asia SHAPIRA, Ra'anana (IL)

(73) Assignee: Ramot at Tel-Aviv University Ltd.

(21) Appl. No.: 14/772,384

(22) PCT Filed: Mar. 13, 2014
(86) PCT No.: PCT/IL2014/050266

§ 371 Date: Sep. 3, 2015

Related U.S. Application Data
(60) Provisional application No. 61/781,326, filed on Mar. 14, 2013.

(51) Int. Cl. G02F 1/35; G02F 1/37; G02B 27/09; G02B 5/32; G02F 1/355

(52) U.S. Cl. CPC G02F 1/3544; G02B 5/32; G02F 1/3501; G02F 1/3553; G02B 27/0944; G02B 27/0927; G02F 1/37; G02F 1/3558; G02F 2001/3548

(57) ABSTRACT

A method and system for beam shaping employing a non-collinear quasi phase-matched interaction in a crystal whose nonlinear coefficient was encoded by a computer generated hologram is provided herein. The same axis is used for both satisfying the phase-matching requirements and encoding the holographic information. This allows one-dimensional beam shaping using a very simple to fabricate nonlinear crystal pattern and two-dimensional beam shaping with high conversion efficiency. Both are demonstrated by converting a fundamental Gaussian beam into Hermite-Gaussian and Laguerre-Gaussian beams at the second harmonic in KTiOPO₄ and stoichiometric lithium tantalate. The suggested scheme enables broad wavelength tuning by simply tilting the crystal.

### TECHNICAL FIELD

The present invention relates to the field of non-linear optics, and more particularly, nonlinear beam shaping by non-collinear interaction.

### BACKGROUND OF THE INVENTION

Optical diffraction occurs when a light beam encounters a periodic structure. Nonlinear diffraction takes place when this periodicity is in a nonlinear coefficient, for example, a periodically altered second order nonlinear coefficient impinged by a pump beam from a light source will result in a diffraction pattern in the second harmonic (SH). Usually the pump propagates perpendicularly with respect to the grating, thereby leading to a symmetric diffraction pattern from both sides of the propagation direction. Schemes for symmetric nonlinear diffraction were extensively studied in recent years, for the cases of Raman-Nath, Cerenkov and Bragg. Breaking the symmetry, i.e. entering the nonlinear crystal at an angle can enlarge the operational bandwidth and in this case, the resulting diffraction pattern is also asymmetrical. Shaping the generated beams in nonlinear interactions is of great interest, since it can save both cost and space compared with the alternative approach of first frequency converting the beam and then manipulating it. In addition, such shaping techniques open new possibilities for all-optical control of beam parameters that cannot be achieved in linear optics. Several approaches for one-dimensional beam shaping where studied, including shaping of the generated amplitude or phase. Arbitrary shaping of both the amplitude and phase was also demonstrated by implementing in the nonlinear regime the concept of computer generated hologram. A common disadvantage to all the above mentioned schemes is that they require two-dimensional modulation of the nonlinear coefficient—usually one axis is used for quasi phase-matching and the second axis for beam shaping. This complicates the design and crystal fabrication, and in addition it poses a limitation when working with some of the more efficient crystals, e.g. potassium titanyl phosphate (KTiOPO₄). Two-dimensional beam shaping was also studied recently by working in a transverse setting of the nonlinear crystal, where both transverse axes are used for encoding the desired pattern and phase-matching is partially obtained using the nonlinear Raman-Nath scheme. The disadvantage of this setup is the resultant low nonlinear conversion efficiency, owing to the partial phase matching.

### SUMMARY OF THE INVENTION

Embodiments of the present invention provide a method and a system for beam shaping employing a non-collinear quasi phase-matched interaction in a crystal whose nonlinear coefficient was encoded by a computer generated hologram. The same axis is used for both satisfying the phase-matching requirements and encoding the holographic information. This allows one-dimensional beam shaping using a very simple to fabricate nonlinear crystal pattern and two-dimensional beam shaping with high conversion efficiency. Both are demonstrated by converting a fundamental Gaussian beam into Hermite-Gaussian and Laguerre-Gaussian beams at the second harmonic in KTiOPO₄ and stoichiometric lithium tantalate. The suggested scheme enables broad wavelength tuning by simply tilting the crystal by a tilt mechanism.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 shows high level schematic block diagrams of the crystals according to some embodiments of the invention.

FIG. 2 shows diagram illustrating an aspect of the system according to some embodiments of the invention; and

FIG. 3 shows graph diagrams illustrating an aspect of the system according to some embodiments of the invention;

FIG. 4 shows graph diagrams illustrating an aspect of the system according to some embodiments of the invention;

FIG. 5 shows graph diagrams illustrating an aspect of the system according to some embodiments of the invention.

The drawings together with the following detailed description make the embodiments of the invention apparent to those skilled in the art.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention, in embodiments thereof, proposes a shaping scheme that provides a solution to both of the above mentioned problems. Specifically, it enables 1D beam shaping by 1D modulation of the nonlinear coefficient, and it enables fully phase matched, and hence efficient scheme for 2D beam shaping. The method according to embodiments of the present invention is based a non-collinear quasi phase-matched interaction, where a binary holographic pattern is encoded on the same crystal axis used for quasi phase-matching. The diffraction is of an asymmetric nature and hence results with a single generated beam, separated from the fundamental frequency (FF). In the two-dimensional case the X-axis of the crystal is used for both quasi phase-matching and encoding the holographic information, whereas the Y-axis is used only for the holographic information. The general expression for the modulation of the nonlinear coefficient, in this case, is given by Eq.(1) below:

d_{NLO}(x,y)=dᵢⱼsign{cos[xG−φ(x,y)]−cos[πq(x,y)]}, Eq.(1)

where dᵢⱼ is an element of the quadratic susceptibility X⁽²⁾ tensor, G is the reciprocal vector in the X direction required for quasi phase-matching, q(x,y)=1/π×asin{A(x,y)}, and A(x, y)exp(iφ(x, y)) is the Fourier transform of the desired wave-front in the first diffraction order. For the process of SH generation G=k₂ sin(α)/cos(θ), where k₂ is the wave-vector of the SH beam, α is the angle of separation between the fundamental frequency (FF) and SH beams and θ is the angle of FF beam propagation inside the crystal in respect to the normal to the crystal facet. Angle θ can be either positive or negative, depending on phase-matching requirements. This differs from previous schemes, where the full vectorial phase-matching condition was not fulfilled and the result of the nonlinear interaction was a symmetrical diffraction pattern with low conversion efficiency.

In the one-dimensional case only the X-axis is employed, for both phase-matching and pattern encoding and the modulation is described by omitting the Y dependence in Eq. (1). This implementation differs from a previously presented technique, where continuous encoding was implemented with two-dimensional patterning, the propagation axis was used for collinear phase-matching and the perpendicular axis for imposing the desired phase on the generated SH. The method suggested here results with a much simpler 1D poling process, hence working with efficient nonlinear crystals with highly non-isotropic poling behavior, such as KTiOPO₄, becomes possible. Moreover, the suggested implementation for both one- and two-dimensional shaping can be employed for a wide range of wavelengths by simply tilting the crystal.

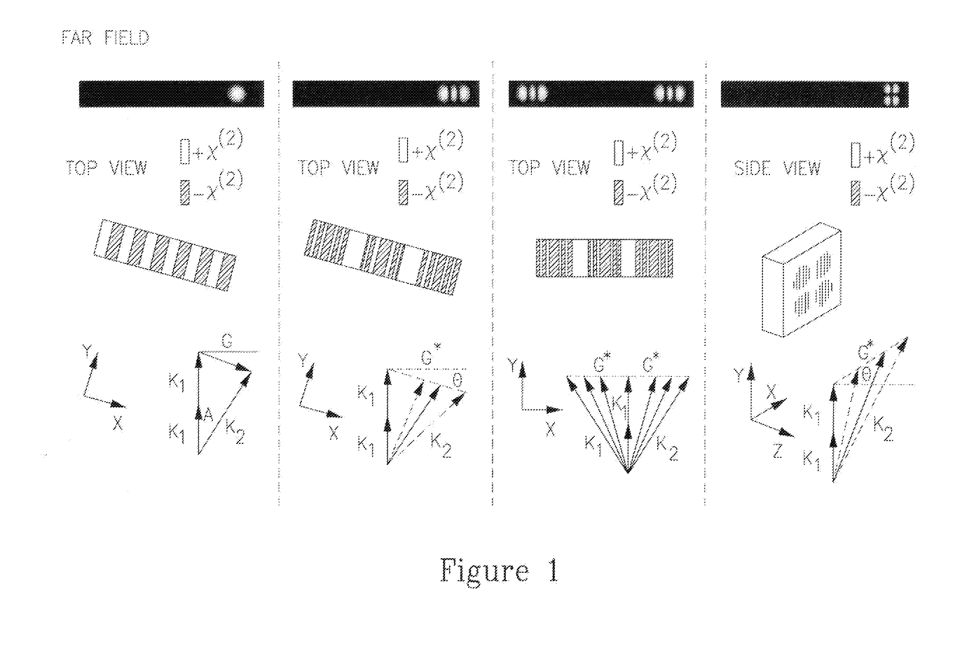

FIG. 1 shows a schematic illustration of the suggested setups, in the one-dimensional case, the FF beam is propagating in a tilt with respect to the Y axis of the crystal. The k-vector diagram is presented to explain the quasi phase-matching scheme. Part (a) in the figure shows the output SH at far field for a simple one-dimensional periodic modulation, part (b) shows the result for encoding an Hermite-Gaussian (HG) beam, HG₂₀¹⁷, with the one-dimensional version of Eq. (1). It is important to note that this technique can also be implemented for a zero tilt angle, as shown in part (c) of FIG. 1. Whereas in the first two cases a single beam is generated, in the latter case two beams are generated symmetrically with respect to the optical axis. Part (d) in the figure illustrates how the concept of asymmetrical diffraction can be employed for two-dimensional beam shaping, showing a result for encoding HG₁₁ with Eq. (1). Symmetrical diffraction pattern with respect to the optical axis in a two-dimensional case is usually not feasible since this configuration requires sub-micron patterning of the nonlinear crystal for phase-matching.

In FIG. 1, shaping nonlinear diffraction setup schematic illustration is shown. Asymmetric nonlinear diffraction for a periodic crystal (a), a crystal encoded with one-dimensional information (b) and with two-dimensional information (d). Symmetric nonlinear diffraction in a crystal encoded with one-dimensional information (c). G* is a local reciprocal crystal vector.

To demonstrate the one-dimensional concept the inventors have fabricated a crystal aimed to generate two beams of the Hermite-Gaussian family, HG₁₀ and HG₂₀ in the process of SH generation. The two-dimensional concept was demonstrated by second harmonic generation of the Hermite-Gaussian HG₁₁ and the Laguerre-Gaussian LG₂₀ beams. The latter beam is a vortex beam with a topological charge of +2.

The experimental demonstration for the one-dimensional shaping was performed on a one-dimensional poled KTiOPO₄ crystal with a carrier frequency, G/2π, of 0.1176 μm⁻¹. This frequency phase-matches an o-eo SH generation of an 1064.5 nm Nd:YAG laser, with the crystal tilted by 0.206 rad (related with θ through Snells' law). Due to encoding, domain widths in the poled crystal varied between 1.6 μm and 4 μm. The length of the crystal in the Y direction was 2 mm The FF source used was a Nd:YAG laser producing 10 ns pulses at a 2 kHz repetition rate at a wavelength of 1064.5 nm The laser beam was focused to the center of the crystal with a cylindrical lens, creating a waist radius of approximately 70 μm and 1 mm in the crystallographic z- and x-directions, respectively. An additional cylindrical lens was placed at the output of the crystal. Two-dimensional shaping was demonstrated on a two-dimensionally poled stoichiometric lithium tantalate (SLT) nonlinear crystal. The carrier frequency in the X direction was 0.125 μm⁻¹, aimed to phase-match an e-ee SH generation of a 1550 nm pump at room temperature, with the crystal tilted by 0.86 rad. Working in this tilted setting allows to use d₃₃ in the nonlinear interaction, the fraction of FF power taking part in such interaction is cos²(θ), where θ is the FF angle. The processes of o-oo and o-eo SH generation results with negligible contribution to the total SH power because in SLT d₃₃ is larger by more than an order of magnitude with respect to d₂₂ and d₂₄. Domain widths in the poled crystal varied between 2 μm and 4.5 μm. The length of the crystal in the Z direction was 0.5 mm. The FF source in this experiment was the signal of an optical parametric oscillator (OPO) producing 4.5 ns pulses at a 10 kHz repetition rate at 1550 nm The beam was focused to the center of the crystal creating a waist radius of approximately 500 μm.

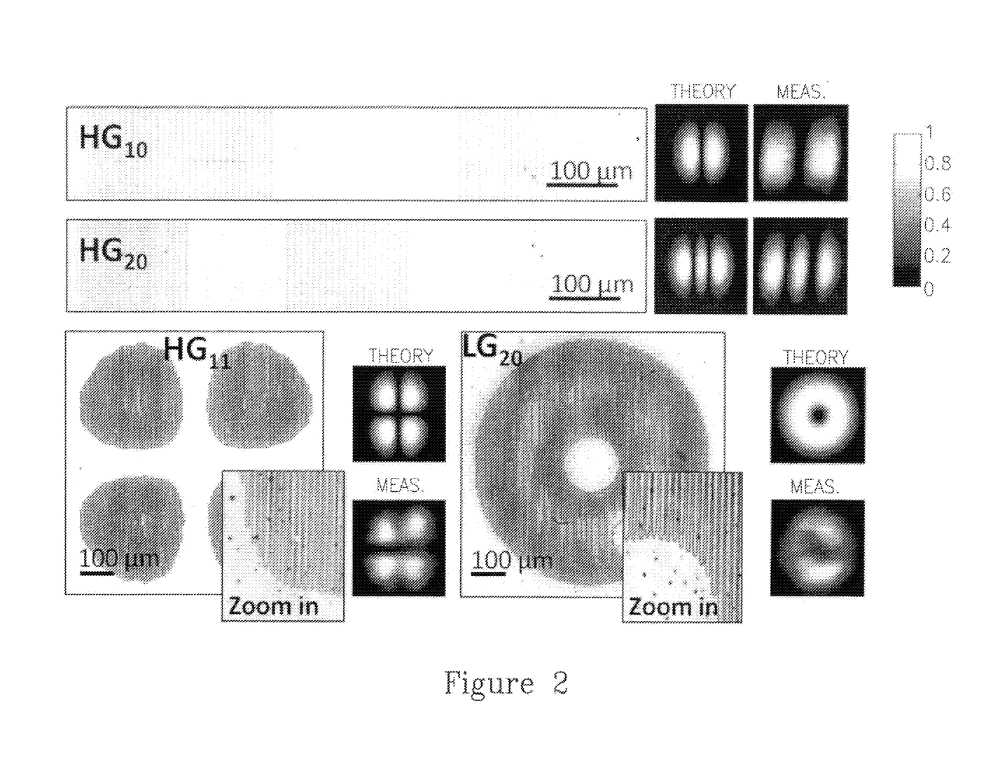

FIG. 2 shows microscopic pictures of the poling structures on the crystal in parts (a), (b), (c) and (d). The high quality of the poling process is evident from the pictures. The desired HG and LG modes were obtained at the far field of the SH and a comparison between theoretical and measured beam shapes is also presented in FIG. 2.

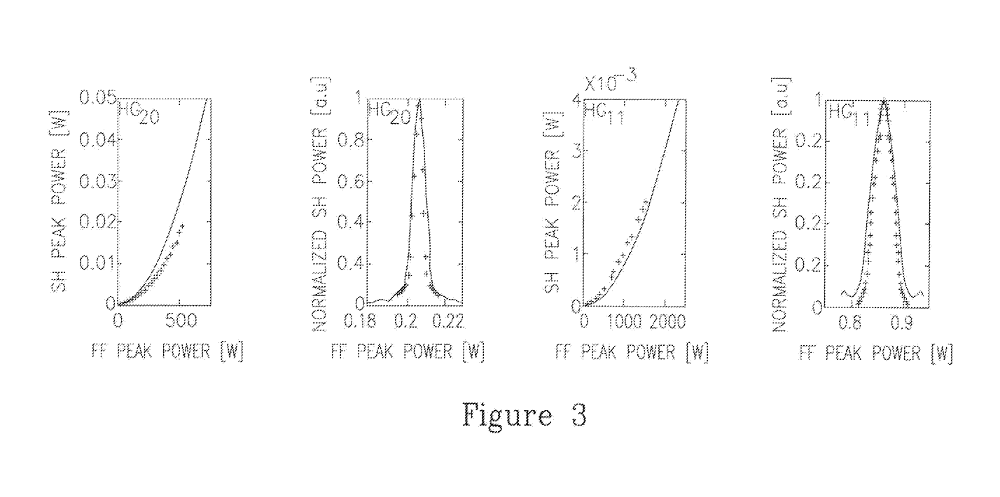

FIG. 3 illustrates a detailed comparison between experimental and predicted results for the HG₂₀ and HG₁₁ beams. Numerical simulations were performed based on the split-step Fourier method, with physical parameters identical to those in the experiment and assuming d₃₁=3.7 μm/V²⁰ for KTiOPO₄ and d₃₃=12.9 μm/V²¹ for SLT. A good fit is observed between the measured and simulated output SH power dependence on input FF power and crystal tilt angle for both experiments. A comparison between expected and measured external conversion efficiencies (for peak pump power) is summarized in Table I for both crystals. We can also estimate the reduction in efficiency owing to the modulation by comparison with standard periodically poled crystals. The expected external conversion efficiency for a periodically poled KTiOPO₄ crystal, such as presented in FIG. 1 part (a) is 2.88×10⁻⁵% W⁻¹, i.e. 2-3 times larger than the predicted efficiency for generating HG₁₀ and HG₂₀ beams. A similar reduction in efficiency is obtained in SLT, in which the efficiency of a periodically poled crystal is 2.34×10⁻⁷% W⁻¹. The observed reduction in efficiency due to modulation is expected since both modulation and phase-matching are implemented on the same axis in both crystals. In addition, Table I also summarizes the spatial correlation between measured and theoretical beam shapes.

The graphs illustrate the comparison between measured (plus sign curves) and predicted (solid curves) results for HG₂₀ and HG₁₁, output power dependence on input power (a) and (c) and output power dependence on crystal tilt angle (b) and (d).

A comparison between predicted and measured conversion efficiencies and beam profile correlation for the measured beams is shown in Table I below.

TABLE I

| | Prediction | Measurement | spatial |
|---|---|---|---|
| | conv. eff. [% W⁻¹] | conv. eff. [% W⁻¹] | correlation |
| HG₁₀ | 1.39 × 10⁻⁵ | 7.3 × 10⁻⁶ | 0.96 |
| HG₂₀ | 9.78 × 10⁻⁶ | 7.17 × 10⁻⁶ | 0.96 |
| HG₁₁ | 7.48 × 10⁻⁸ | 4.85 × 10⁻⁸ | 0.93 |
| LG₂₀ | 1.03 × 10⁻⁷ | 5.43 × 10⁻⁸ | 0.87 |

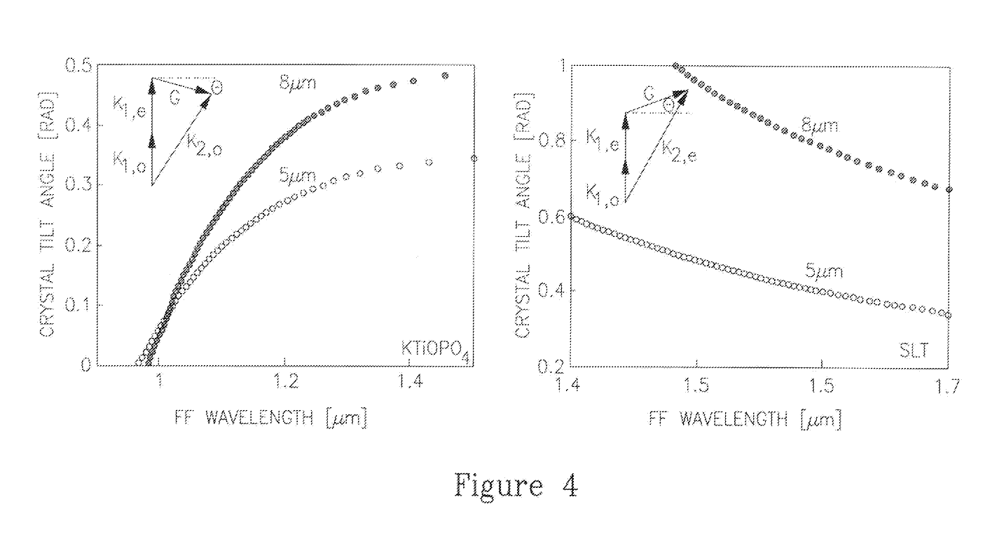

An advantage of the suggested scheme in KTiOPO₄ is the wide range of temperatures in which this device operates, since the temperature change only leads to a small change in the angle of the generated beam. The device exhibits an almost constant output power in the examined range of 25° C.-150° C. In both crystals, the advantage of working with an asymmetric scheme is the flexibility of the chosen work point, i.e. phase-matching is achieved for different crystal tilt angles at different pump wavelengths. This flexibility is demonstrated in FIG. 4, where the required crystal tilt angle versus FF wavelength is presented for the two materials, KTiOPO₄ and SLT, at room temperature, for two different poling periods. Tunability of more than 200 nm is achieved in both cases, by simply changing the tilt angle. FIG. 4 illustrates possible work points in asymmetrical diffraction in an o-eo SH generation in KTiOPO₄ at two different carrier periods (a) and e-ee SH generation in SLT (b). It would be important to note that embodiments of the present invention is not limited only to Hermite-Gaussian or Laguerie-Gaussian beams and any arbitrary one- and two-dimensional modulation can be generated in the SH, e.g Airy beam, Parabolic beam, etc. Also, it is now possible to implement a two-dimensional lens in the nonlinear process, previously demonstrated only in one dimension.

A comparison between measured conversion efficiency for one-dimensional shaping in the presented method and the previously presented technique, when taking into account the different interaction lengths and different nonlinear coefficients, shows an improvement by a factor of 2. The improvement is due to the fact that in the present method SH power is only concentrated in the shaped diffraction order. A comparison for the two-dimensional shaping case, comparing results of the experiment carried out in accordance with embodiments of the present invention and reported results of previously known method taking into account the different FF beam waist, shows a dramatic improvement of 5 orders of magnitude. This emphasizes the advantage of the asymmetrical diffraction scheme. An additional option for achieving efficient two-dimensional beam shaping is working with two-dimensionally patterned nonlinear slanted crystals. In this case the nonlinear interaction would be collinear and the diffraction pattern symmetrical, the propagation axis would serve for phase-matching and the two perpendicular axes for encoding the holographic pattern.

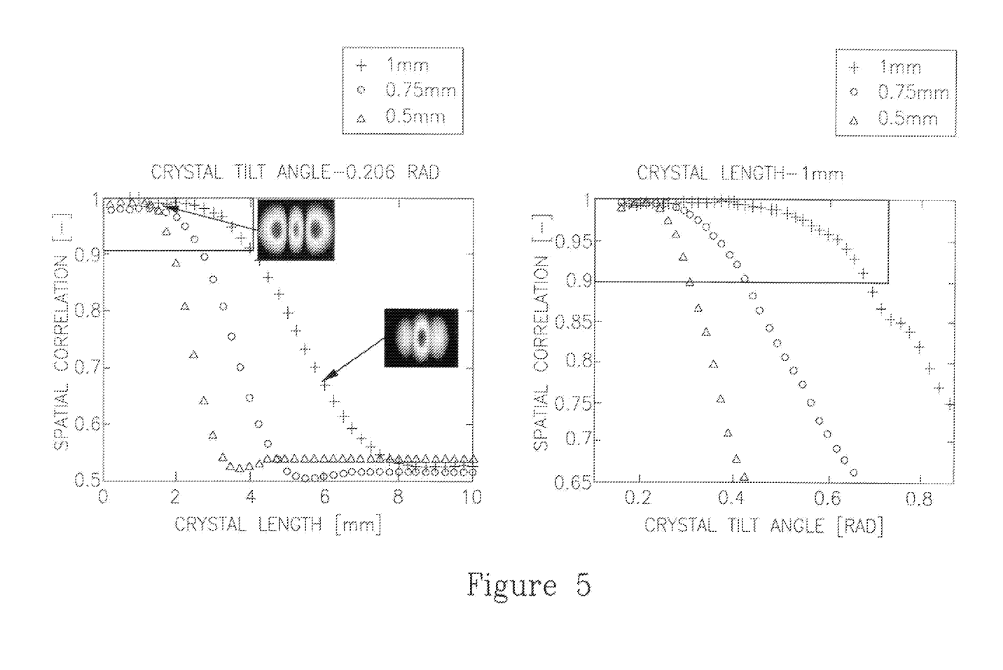

The nonlinear process described herein is non-collinear and the pattern described in Eq. (1) does not depend on the tilt angle of the crystal. It is hence important to state the geometrical limitations of the chosen work point in terms of tilt angle, crystal length and the beam waist of the pump The inventors have studied the influence of the above parameters by examining the simulated spatial correlation for the case of generating an HG₂₀ in KTiOPO₄, the results are summarized in FIG. 5. If a spatial correlation higher than 90% is sought after, marked by the frame in FIG. 5, it can be seen that this is achieved when L×tan(θ)≦0.45 w₀, where L is the length of the crystal in the direction of propagation, θ is the angle of the pump beam propagation inside the crystal (related with the crystal tilt angle through Snells' law) and w₀ is its waist The experiments we report in this letter fulfill this condition—for SLT L×tan(θ)/w₀ is 0.38, and for KTiOPO₄ it is 0.23. FIG. 5 illustrates simulated spatial correlation for HG₂₀ generation in KTiOPO₄ for three pump beam waists (0.5, 0.75 and 1 mm), as a function of crystal length (a) and crystal tilt angle (b). Insets in part (a) show the generated beam at different correlation values.

In conclusion, embodiments of the present invention procide a scheme for one- and two-dimensional beam shaping in nonlinear wave mixing based on non-collinear phase-matching. This is achieved by introducing both phase-matching and encoded information on the same crystal axis. The concept was demonstrated by converting a fundamental HG₀₀ Gaussian beam light into HG₁₀, HG₂₀, HG₁₁ and LG₂₀, beams at the second harmonic. In the one-dimensional case the scheme requires a simple one-dimensional poling pattern to efficiently shape the result of the interaction. In the two-dimensional case the scheme offers a major improvement in conversion efficiency of the shaping process. In both cases, working with a wide range of pump wavelengths is possible by changing the tilt angle of the crystal.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Embodiments of the invention may include features from different embodiments disclosed above, and embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A system for beam shaping comprising:
a light source configured to generate a pump beam; and
a crystal having a nonlinear coefficient encoded by a holographic pattern,
wherein the pump beam is configured to cause a non-collinear quasi phase-matched interaction at the crystal, along a crystal axis, wherein said a holographic pattern is encoded on said crystal axis used for said quasi phase-matching.

2. The system according to claim 1, further comprising a tilt mechanism configured to tilt said crystal, to yield beam shaping, in accordance with the tilt angle.

3. The system according to claim 1, wherein said holographic pattern comprises a binary holographic pattern.

4. The system according to claim 1, wherein said holographic pattern is a computer generated hologram.

5. The system according to claim 1, wherein the beam shaping is one dimensional and is achieved by one dimensional modulation of said nonlinear coefficient.

6. The system according to claim 6, wherein a diffraction caused by the interaction is of an asymmetric nature and results with a single generated beam, separated from a fundamental frequency of the beam.

7. The system according to claim 1, wherein the beam shaping is two dimensional and is achieved by using an X-axis of said crystal for the quasi phase-matching and the encoding the holographic pattern, and wherein a Y-axis is used only for the holographic pattern.

8. The system according to claim 1, wherein the beam shaping is two dimensional and is achieved by using two-dimensionally patterned nonlinear slanted crystals, wherein the nonlinear interaction is collinear and a diffraction pattern symmetrical, a propagation axis serving for the phase-matching and two perpendicular axes for encoding the holographic pattern.

9. A method for beam shaping comprising:
generating a pump beam; and
aiming the pump beam at a crystal having a nonlinear coefficient encoded by a holographic pattern,
wherein the pump beam is configured to cause a non-collinear quasi phase-matched interaction at the crystal, along a crystal axis, wherein said a holographic pattern is encoded on said crystal axis used for said quasi phase-matching.

10. The method according to claim 9, further comprising tilting said crystal, to yield beam shaping, in accordance with the tilt angle.

11. The method according to claim 9, wherein said holographic pattern comprises a binary holographic pattern.

12. The method according to claim 9, wherein said holographic pattern is a computer generated hologram.

13. The method according to claim 9, wherein the beam shaping is one dimensional and is achieved by one dimensional modulation of said nonlinear coefficient.

14. The method according to claim 13, wherein a diffraction caused by the interaction is of an asymmetric nature and results with a single generated beam, separated from a fundamental frequency of the beam.

15. The method according to claim 9, wherein the beam shaping is two dimensional and is achieved by using an X-axis of said crystal for the quasi phase-matching and the encoding the holographic pattern, and wherein a Y-axis is used only for the holographic pattern.

16. The method according to claim 9, wherein the beam shaping is two dimensional and is achieved by using two-dimensionally patterned nonlinear slanted crystals, wherein the nonlinear interaction is collinear and a diffraction pattern symmetrical, a propagation axis serving for the phase-matching and two perpendicular axes for encoding the holographic pattern.
